(19) United States
(12) Patent Application Publication
(10) Pub. No.: US 2002/0057047 A1
(43) Pub. Date: May 16, 2002

(54) Deflection yoke for color cathode-ray tube having auxiliary coils obviating misconvergence

(75) Inventor: Koji Nakajima, Shiga (JP)

Correspondence Address: YOUNG & THOMPSON, 745 SOUTH 23RD STREET 2ND FLOOR, ARLINGTON, VA, 22202

(73) Assignee: NEC Corporation

(21) Appl. No.: 09/986,957

(22) Filed: Nov. 13, 2001

(30) Foreign Application Priority Data
Nov. 13, 2000 (JP) 2000-344738

(51) Int. Cl. H01J 29/76

(52) U.S. Cl. 313/440

(57) ABSTRACT

A deflection yoke for an in-line self convergence type color cathode-ray tube. The deflection yoke includes an auxiliary coil assembly having auxiliary coils which are electrically coupled with vertical deflection coils and which produce electric field for compensating for misconvergence caused by comatic aberration. The auxiliary coil assembly also comprises a pair of U-shaped cores which are opposed to each other via a neck portion of the color cathode-ray tube and on which the auxiliary coils are wound. The deflection yoke comprises one or more magnetic material pieces, for example, a pair of magnetic material pieces which are disposed on respective one of said U-shaped cores. The one or more magnetic material pieces are preferably made of high permeability metal.

### FIELD OF THE INVENTION

The present invention relates generally to a deflection yoke for a color cathode-ray tube (or a color Braun tube), and a color cathode-ray tube assembly on which the deflection yoke is mounted. More particularly, the present invention relates to a deflection yoke having an auxiliary coil assembly by which misconvergence caused by comatic aberration can be appropriately compensated at low cost.

### BACKGROUND OF THE INVENTION

In an in-line gun type color cathode-ray tube, there are provided three electron guns for blue (B), green (G) and red (R) colors which are disposed within a vacuum valve and which are disposed within the same plane of a horizontal (X) direction. Electron beams emitted from these three electron guns are deflected by a deflection yoke composed of electromagnetic coils toward horizontal (X) and vertical (Y) directions, and then strike a fluorescent screen via a shadow mask.

In such in-line gun type color cathode-ray tube, when the electron beams are deflected toward X and Y directions, the electron beams pass through deflection electromagnetic field which is strongly distorted to deflect the electron beams. Therefore, there occurs a problem that three electron beams do not completely converge on one point, that is, the so-called misconvergence occurs.

In order to solve such problem, an in-line self convergence system is usually used as shown in FIGS. 2A and 2B. In FIGS. 2A and 2B, there are shown three electron beams B, G and R emitted from an in-line electron gun system including three electron guns disposed within the same plane of a horizontal (X) direction. In the in-line self convergence system, these electron beams B, G and R are passed through a combination of a magnetic field for horizontal deflection 21 shown in FIG. 2A and a magnetic field for vertical deflection 22 shown in FIG. 2B. The magnetic field for horizontal deflection 21 is a “pincushion type” magnetic field and a magnetic field for vertical deflection 22 is a “barrel type” magnetic field. Thereby, it becomes possible to converge the three electron beams B, G and R approximately onto one point at any portion on an image screen.

The in-line self convergence system has the merits that an electric circuit, adjustment work and the like required for realizing convergence of the electron beams B, G and R can be decreased and the convergence can be realized with high precision.

However, when the electron beams B, G and R pass through the pincushion type magnetic field for horizontal deflection 21 shown in FIG. 2A and the barrel type magnetic field for vertical deflection 22 shown in FIG. 2B, misconvergence of electron beams occurs due to coma or comatic aberration as shown in FIG. 3. FIG. 3 shows a condition in which a rectangular shaped line image is displayed on a screen of a conventional color cathode-ray tube. From FIG. 3, it can be seen that, although an image component of blue color B and an image component of red color R coincide with each other, an image component of green color G does not coincide with the image components of other colors (B and R).

In order to obviate the above-mentioned misconvergence caused by the coma, auxiliary coils (L1 and L2) shown in FIG. 4 are usually used. In FIG. 4, reference symbols V1 and V2 designate vertical deflection coils in the deflection yoke, and the auxiliary coils L1 and L2 are coupled in series with the vertical deflection coils V1 and V2.

FIG. 5 shows a schematic structure of an auxiliary coil assembly including the auxiliary coils L1 and L2. As shown in FIG. 5, the auxiliary coils L1 and L2 are wound on a pair of U-shaped cores 51A and 51B, respectively, which are made of magnetic material and which are opposed to each other. The auxiliary coils L1 and L2 form a pincushion type magnetic field 52. The pincushion type magnetic field has higher magnetic field density at a location of electron beam G than at each of locations of electron beams B and R. Therefore, the electron beam G is deflected more largely in Y direction than the electron beams B and R. Thereby, misconvergence which is mentioned above with reference to FIG. 3 and which is caused by the coma is mitigated in Y direction. Misconvergence in X direction can usually be mitigated by controlling a deflection current of horizontal deflection coils not shown in the drawing.

In the above-mentioned method of compensation which uses the auxiliary coils L1 and L2, theoretically, it is possible to mitigate misconvergence caused by the coma and shown in FIG. 3 relatively easily. However, in the above-mentioned method of compensation, it is necessary to use the auxiliary coils L1 and L2 whose characteristics are precisely matched, in order to sufficiently mitigate misconvergence. In practice, it is very difficult to precisely match characteristics of the auxiliary coils L1 and L2 without dispersion for every pair of auxiliary coils.

FIG. 6 exaggeratedly illustrates a condition in which characteristics of the auxiliary coils L1 and L2 are unbalanced. In practice, the auxiliary coils L1 and L2 often become unbalanced like this, because each of the auxiliary coils L1 and L2 is not wound uniformly on the respective cores 51A and 51B. When the characteristics of the auxiliary coils L1 and L2 are unbalanced like this, a pincushion type magnetic field 62 does not become symmetry in up and down direction, i.e., in Y direction. Therefore, with respect to the force F×B, F×G and F×R which are exerted on the electron beams B, G and R by the pincushion type magnetic field 62 in X direction, the following relation does not hold true:

(F×B+F×R)/2=F×G.

When the above-mentioned relation, i.e.,

(F×B+F×R)/2=F×G

does not hold true, misconvergence occurs as illustrated in FIG. 7. In the misconvergence shown in FIG. 7, beam spots produced by an electron beam G do not coincide with beam spots produced by electron beams B and R along the vertical line passing through the center of a picture screen.

Conventionally, in order to avoid such misconvergence, each pair of auxiliary coils L1 and L2 are carefully selected or sorted such that the auxiliary coils L1 and L2 of the pair have matched characteristics. However, such method raises manufacturing costs.

### SUMMARY OF THE INVENTION

The inventor of the present invention directed his attention to the fact that the auxiliary coils which do not have matched characteristics can be obtained easily at low costs, and invented a simple way of matching the characteristics of such auxiliary coils and of making good use of such auxiliary coils. Thereby, it becomes possible to obtain performance of misconvergence compensation similar to that obtained when the auxiliary coils having precisely matched characteristics are selected, at much lower costs than those when the auxiliary coils having matched characteristics are selected.

Therefore, it is an object of the present invention to provide a deflection yoke for a color cathode-ray tube which provides high convergence performance with reduced costs.

It is another object of the present invention to make good use of auxiliary coils which do not have matched characteristics and to provide a deflection yoke for a color cathode-ray tube which provides high convergence performance with reduced costs.

It is still another object of the present invention to provide a deflection yoke which has superior convergence performance to that of a deflection yoke having auxiliary coils selected to match characteristics thereof and which has much lower costs than that of the deflection yoke having auxiliary coils selected to match characteristics thereof.

It is still another object of the present invention to provide a color cathode-ray tube assembly in which a deflection yoke is mounted on an in-line self convergence type color cathode-ray tube and which provides high convergence performance at low cost.

It is still another object of the present invention to provide a color cathode-ray tube assembly in which a deflection yoke is mounted on an in-line self convergence type color cathode-ray tube and which provides high color picture quality at low cost.

It is still another object of the present invention to obviate the disadvantages of the conventional deflection yoke and of the color cathode-ray tube assembly using the conventional deflection yoke.

According to an aspect of the present invention, there is provided a deflection yoke for an in-line self convergence type color cathode-ray tube, the deflection yoke comprising: an auxiliary coil assembly having auxiliary coils which are electrically coupled with vertical deflection coils and which produce electric field for compensating for misconvergence; and one or more magnetic material pieces disposed in the proximity of the auxiliary coils.

In this case, it is preferable that the auxiliary coil assembly comprises a pair of U-shaped cores which are opposed to each other via a neck portion of the color cathode-ray tube disposed therebetween and on which the auxiliary coils are wound.

It is also preferable that the one or more magnetic material pieces are attached to one or more of the U-shaped cores in the pair of U-shaped cores.

It is further preferable that the auxiliary coil assembly compensates for misconvergence caused by comatic aberration.

It is advantageous that the one or more magnetic material pieces comprise a pair of magnetic material pieces which are disposed on opposite sides with respect to the center line of the color cathode-ray tube.

It is also advantageous that each of the pair of magnetic material pieces is disposed on and in contact with respective one of the U-shaped cores.

It is further advantageous that the one or more magnetic material pieces are made of high permeability metal.

It is preferable that the high permeability metal is a metal selected from a group consisting of permalloy, silicon steel, iron and iron-cobalt alloy.

It is also preferable that the number of the one or more magnetic material pieces is selected such that balanced pincushion type magnetic field is provided by the auxiliary coil assembly.

It is further preferable that the location of each of the one or more magnetic material pieces is selected such that balanced pincushion type magnetic field is provided by the auxiliary coil assembly.

It is advantageous that the size of each of the one or more magnetic material pieces is selected such that balanced pincushion type magnetic field is provided by the auxiliary coil assembly.

According to another aspect of the present invention, there is provided an in-line self convergence type color cathode-ray tube on which a deflection yoke is mounted, the deflection yoke comprising: an auxiliary coil assembly having auxiliary coils which are electrically coupled with vertical deflection coils and which produce electric field for compensating for misconvergence; and one or more magnetic material pieces disposed in the proximity of the auxiliary coils.

In this case, it is preferable that the auxiliary coil assembly comprises a pair of U-shaped cores which are opposed to each other via a neck portion of the color cathode-ray tube disposed therebetween and on which the auxiliary coils are wound.

It is also preferable that the one or more magnetic material pieces comprise a pair of magnetic material pieces which are disposed on opposite sides with respect to the center line of the color cathode-ray tube.

It is further preferable that each of the pair of magnetic material pieces is disposed on and in contact with respective one of the U-shaped cores.

It is advantageous that the one or more magnetic material pieces are made of high permeability metal.

It is also advantageous that the high permeability metal is a metal selected from a group consisting of permalloy, silicon steel, iron and iron-cobalt alloy.

### BRIEF DESCRIPTION OF THE DRAWINGS

These and other features, and advantages, of the present invention will be more clearly understood from the following detailed description taken in conjunction with the accompanying drawings, in which like reference numerals designate identical or corresponding parts throughout the figures, and in which:

FIG. 1A is a partial enlarged plan view showing a schematic structure of a portion including an auxiliary coil assembly of a deflection yoke as an embodiment of the present invention;

FIG. 1B is a schematic front view showing the portion including the auxiliary coil assembly of the deflection yoke shown in FIG. 1A;

FIG. 2A is an illustration showing a pincushion type magnetic field for horizontal deflection used in a conventional in-line self convergence system;

FIG. 2B is an illustration showing a barrel type magnetic field for vertical deflection used in a conventional in-line self convergence system;

FIG. 3 is an illustration showing a condition in which a rectangular shaped line image is displayed on a screen of a conventional color cathode-ray tube;

FIG. 4 is a circuit diagram showing a circuit including auxiliary coils for decreasing misconvergence and vertical deflection coils in a conventional deflection yoke;

FIG. 5 is a schematic front view showing a structure of a portion including an auxiliary coil assembly having auxiliary coils of a conventional deflection yoke and showing a pincushion type magnetic field when characteristics of the auxiliary coils are balanced;

FIG. 6 is a schematic front view showing a structure of a portion including an auxiliary coil assembly having auxiliary coils of a conventional deflection yoke and showing a pincushion type magnetic field when characteristics of the auxiliary coils are unbalanced; and

FIG. 7 is an illustration showing a condition of misconvergence which occurs in the conventional structure shown in FIG. 6.

### DESCRIPTION OF A PREFERRED EMBODIMENT

With reference to the drawings, an embodiment of the present invention will be described in detail.

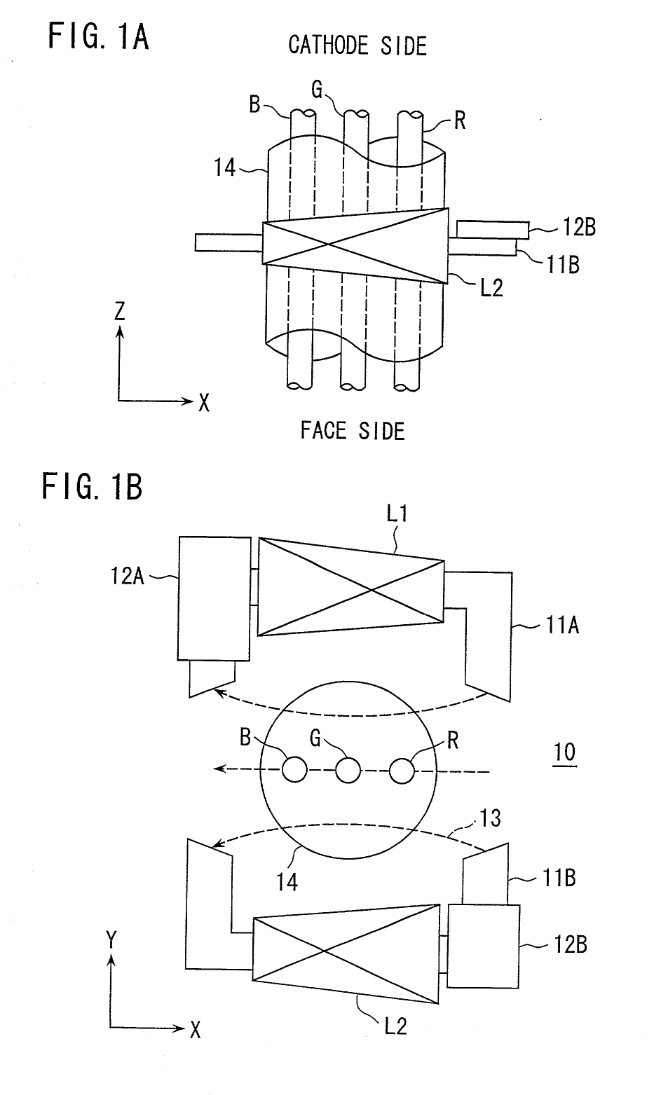

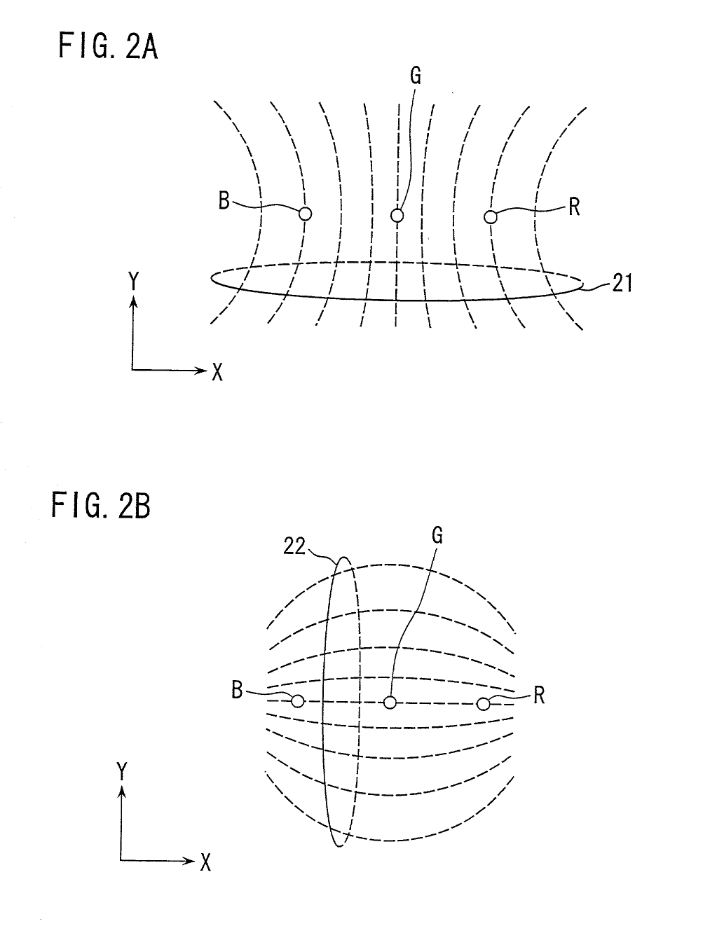

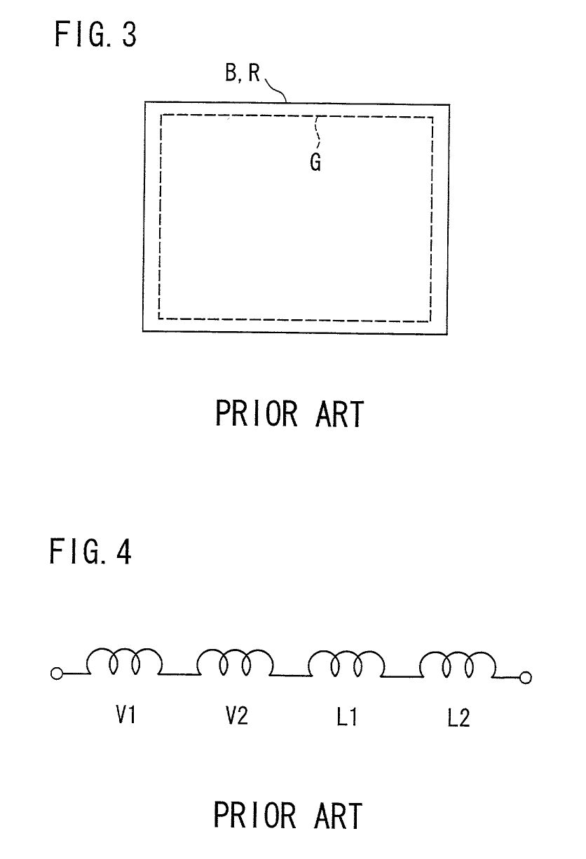

FIG. 1A is a partial enlarged plan view of an auxiliary coil assembly of a deflection yoke 10 as an embodiment of the present invention. FIG. 1B is a partial front view of the auxiliary coil assembly shown in FIG. 1A. More particularly, FIG. 1A is a partial enlarged plan view showing the auxiliary coil assembly of the deflection yoke 10 and the like when a portion of the rear end side of the deflection yoke where the auxiliary coil assembly is disposed is viewed from upside. Although not shown in FIG. 1A, there are provided vertical deflection coils and horizontal deflection coils which are disposed next to the auxiliary coil assembly on the side of a face (or a picture screen) of a color cathode-ray tube not shown in the drawing. The deflection yoke includes the vertical and horizontal deflection coils and the auxiliary coil assembly. FIG. 1B is a front view showing the auxiliary coil assembly and the like when viewed from the side of a cathode not shown in the drawing.

In FIGS. 1A and 1B, reference symbols L1 and L2 designate auxiliary coils. Reference symbols 11A and 11B are U-shaped cores on which the auxiliary coils L1 and L2 are respectively wound. The U-shaped cores 11A and 11B are opposed to each other via a neck portion 14 of a color cathode-ray tube disposed therebetween. Reference symbols B, G and R designate an electron beam of blue (B) color, an electron beam of green (G) color and an electron beam of red (R) color, respectively.

The auxiliary coil assembly of the deflection yoke 10 according to the present embodiment further comprises a pair of magnetic material pieces 12A and 12B attached to the cores 11A and 11B. The magnetic material pieces 12A and 12B can be bonded to the cores 11A and 11B by adhesive and the like. It is also possible to dispose the magnetic material pieces 12A and 12B in the proximity of the cores 11A and 11B or of the auxiliary coils L1 and L2, respectively. The size, shape and the like of the magnetic material pieces 12A and 12B are not always the same, but may differ depending on the desired compensation effect for the auxiliary coils L1 and L2.

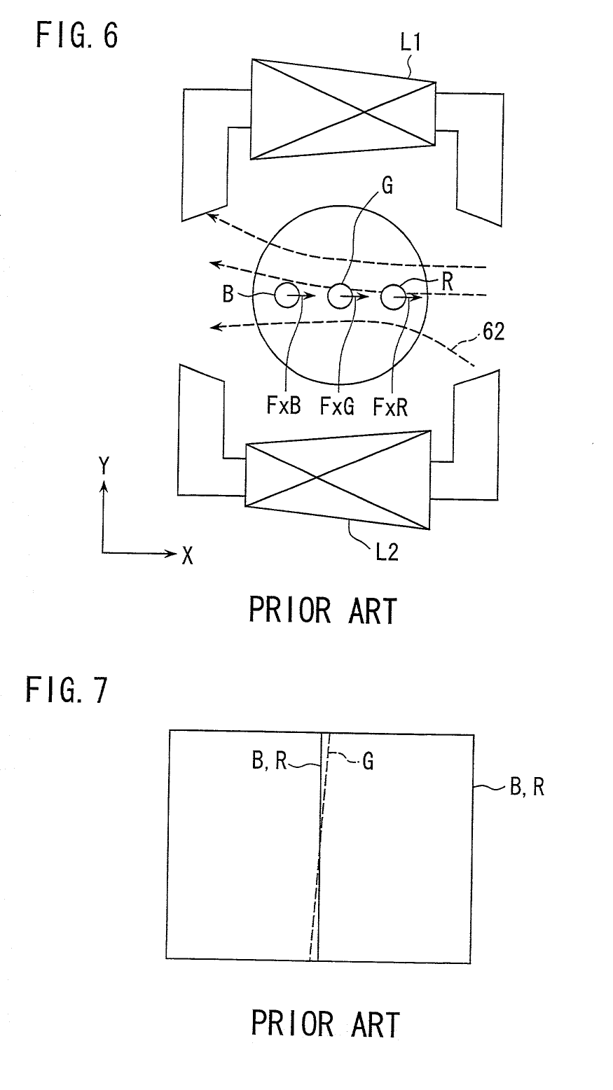

According to the structure shown in FIGS. 1A and 1B, it is possible to obtain balanced pincushion type magnetic field 13 as shown in FIG. 1B, even when characteristics of the auxiliary coils L1 and L2 without the magnetic material pieces 12A and 12B are unbalanced as shown in FIG. 6. The magnetic material pieces 12A and 12B have the property of concentrating magnetic fluxes into the magnetic material pieces 12A and 12B themselves. Therefore, by attaching the magnetic material pieces 12A and 12B to appropriate sides of the cores 11A and 11B, respectively, it is possible to balance the pincushion type magnetic field and to make the pincushion type magnetic field symmetrical in up and down direction, i.e., in Y direction.

It is preferable that each of the magnetic material pieces 12A and 12B is made of metal having high magnetic permeability. Among such metals having high magnetic permeability, permalloy, silicon steel, iron, and iron-cobalt alloy are suitable for the magnetic material pieces 12A and 12B, for example. Permalloy (nickel-iron alloy) has the largest permeability and, therefore, it is possible to obtain the largest compensation effect. Iron-cobalt alloy has large compensation effect next to permalloy. Compensation effect of silicon steel is slightly lower than other metals having high magnetic permeability, but silicon steel is less expensive. Compensation effect of iron is the lowest among other materials mentioned above, but the price of iron is very low. Although the compensation effect of iron is relatively low, in practice, such low compensation effect is often sufficient to realize the auxiliary coil assembly having balanced pincushion type magnetic field according to the present invention. Also, the above-mentioned materials other than silicon steel have relatively small hysteresis, and do not affect convergence characteristics provided by other components. Therefore, it is possible to easily adjust and compensate misconvergence like that illustrated in FIG. 7. It is preferable to select suitable material or materials, taking the above-mentioned characteristics of the materials such as properties, costs and the like into consideration. As an example, it is possible to use the magnetic material pieces 12A and 12B having the same size and made of the same material, for deflection yokes of the same manufacturing lot. It is also possible to select material or materials suitable for each deflection yoke such that the best compensation effect for the deflection yoke can be obtained.

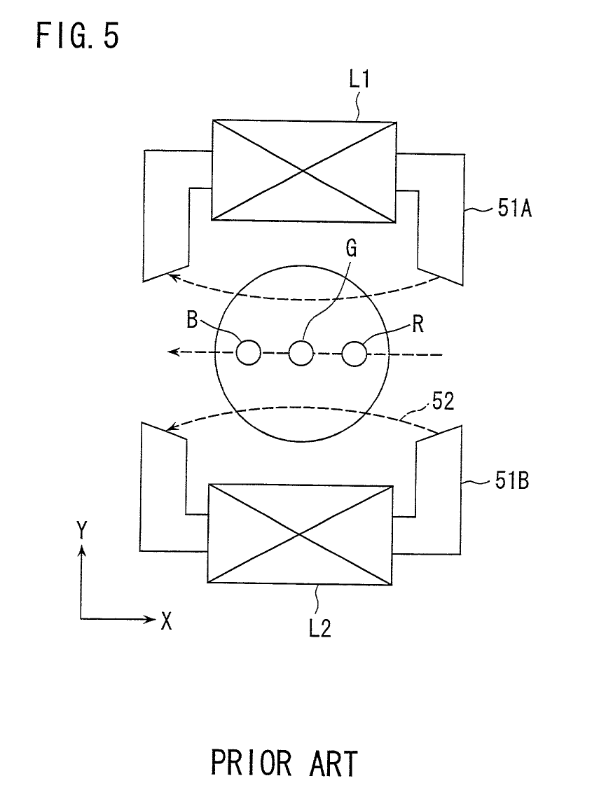

Therefore, even if characteristics of the auxiliary coils L1 and L2 in the deflection yoke 10 are unbalanced, it is possible to balance the characteristics of the auxiliary coils L1 and L2 by attaching the magnetic material pieces 12A and 12B to the auxiliary coils L1 and L2, respectively and to avoid occurrence of misconvergence shown in FIG. 7. That is, it is possible to obtain characteristics equivalent to those of the deflection yoke in which characteristics of the auxiliary coils L1 and L2 are well balanced as shown in FIG. 5.

In the conventional deflection yoke, it was necessary to select and use the auxiliary coils which have well balanced characteristics. Therefore, costs of the conventional deflection yoke were high. On the other hand, in the deflection yoke according to the present invention, almost all the auxiliary coils can be used without selecting matched pair of the auxiliary coils and, therefore, costs of the deflection yoke according to the present invention can be much reduced.

By mounting the deflection yoke according to the present invention, it is possible to realize a color cathode-ray tube in which misconvergence is very small and which has good picture quality.

In the above-mentioned embodiment, a pair of magnetic material pieces 12A and 12B are disposed at locations on the U-shaped cores 11A and 11B opposing to each other via the center line of the color cathode-ray tube on which the deflection yoke is mounted. That is, a pair of magnetic material pieces 12A and 12B are disposed approximately on a diagonal line of a rectangle formed by the U-shaped cores 11A and 11B opposed to each other. However, the location(s) in which the magnetic material piece(s) are disposed and/or the number of the magnetic material piece(s) can be determined for each of the deflection yokes such that the pincushion type magnetic field 13 becomes symmetrical in up and down direction. That is, depending on the condition of balance of characteristics of the auxiliary coils L1 and L2, the number of the magnetic material piece(s) can be one, or more than two. Also, the location(s) of the magnetic material piece(s) can be varied depending on the condition of balance of characteristics of the auxiliary coils L1 and L2. In the above-mentioned embodiment, a pair of magnetic material pieces 12A and 12B are disposed approximately on a diagonal line of the U-shaped cores 11A and 11B and are disposed in contact with the U-shaped cores. In place of such constitution, it is also possible to dispose the magnetic material piece or pieces only on one of the U-shaped cores. However, it is usually preferable that a pair of magnetic material pieces are disposed approximately on a diagonal line of the U-shaped cores and in contact with the U-shaped cores.

As mentioned above, according to the present invention, even if characteristics of the auxiliary coils in the deflection yoke are unbalanced, it is possible to balance the characteristics of the auxiliary coils by attaching the magnetic material pieces to the auxiliary coils or by disposing the magnetic material pieces in the proximity of the auxiliary coils, and to obviate occurrence of misconvergence. That is, it is possible to obtain characteristics equivalent to those of the deflection yoke in which characteristics of the auxiliary coils are well balanced. By mounting the deflection yoke according to the present invention, it is possible to realize a color cathode-ray tube in which misconvergence is very small and which has good picture quality, at low cost.

In the foregoing specification, the invention has been described with reference to specific embodiments. However, one of ordinary skill in the art appreciates that various modifications and changes can be made without departing from the scope of the present invention as set forth in the claims below. Accordingly, the specification and figures are to be regarded in an illustrative sense rather than a restrictive sense, and all such modifications are to be included within the scope of the present invention. Therefore, it is intended that this invention encompasses all of the variations and modifications as fall within the scope of the appended claims.

What is claimed is:

1. A deflection yoke for an in-line self convergence type color cathode-ray tube, said deflection yoke comprising:
an auxiliary coil assembly having auxiliary coils which are electrically coupled with vertical deflection coils and which produce electric field for compensating for misconvergence; and
one or more magnetic material pieces disposed in the proximity of said auxiliary coils.

2. A deflection yoke as set forth in claim 1, wherein said auxiliary coil assembly comprises a pair of U-shaped cores which are opposed to each other via a neck portion of said color cathode-ray tube disposed therebetween and on which said auxiliary coils are wound.

3. A deflection yoke as set forth in claim 2, wherein said one or more magnetic material pieces are attached to one or more of said U-shaped cores in said pair of U-shaped cores.

4. A deflection yoke as set forth in claim 1, wherein said auxiliary coil assembly compensates for misconvergence caused by comatic aberration.

5. A deflection yoke as set forth in claim 2, wherein said one or more magnetic material pieces comprise a pair of magnetic material pieces which are disposed on opposite sides with respect to the center line of said color cathode-ray tube.

6. A deflection yoke as set forth in claim 5, wherein each of said pair of magnetic material pieces is disposed on and in contact with respective one of said U-shaped cores.

7. A deflection yoke as set forth in claim 1, wherein said one or more magnetic material pieces are made of high permeability metal.

8. A deflection yoke as set forth in claim 7, wherein said high permeability metal is a metal selected from a group consisting of permalloy, silicon steel, iron and iron-cobalt alloy.

9. A deflection yoke as set forth in claim 1, wherein the number of said one or more magnetic material pieces is selected such that balanced pincushion type magnetic field is provided by said auxiliary coil assembly.

10. A deflection yoke as set forth in claim 1, wherein the location of each of said one or more magnetic material pieces is selected such that balanced pincushion type magnetic field is provided by said auxiliary coil assembly.

11. A deflection yoke as set forth in claim 1, wherein the size of each of said one or more magnetic material pieces is selected such that balanced pincushion type magnetic field is provided by said auxiliary coil assembly.

12. An in-line self convergence type color cathode-ray tube on which a deflection yoke is mounted, said deflection yoke comprising:
an auxiliary coil assembly having auxiliary coils which are electrically coupled with vertical deflection coils and which produce electric field for compensating for misconvergence; and
one or more magnetic material pieces disposed in the proximity of said auxiliary coils.

13. An in-line self convergence type color cathode-ray tube as set forth in claim 12, wherein said auxiliary coil assembly comprises a pair of U-shaped cores which are opposed to each other via a neck portion of said color cathode-ray tube disposed therebetween and on which said auxiliary coils are wound.

14. An in-line self convergence type color cathode-ray tube as set forth in claim 12, wherein said one or more magnetic material pieces comprise a pair of magnetic material pieces which are disposed on opposite sides with respect to the center line of said color cathode-ray tube.

15. An in-line self convergence type color cathode-ray tube as set forth in claim 14, wherein each of said pair of magnetic material pieces is disposed on and in contact with respective one of said U-shaped cores.

16. An in-line self convergence type color cathode-ray tube as set forth in claim 12, wherein said one or more magnetic material pieces are made of high permeability metal.

17. An in-line self convergence type color cathode-ray tube as set forth in claim 16, wherein said high permeability metal is a metal selected from a group consisting of permalloy, silicon steel, iron and iron-cobalt alloy.
